(19) United States
(12) Patent Application Publication
(10) Pub. No.: US 2005/0145423 A1
(43) Pub. Date: Jul. 7, 2005

(54) Agricultural spreaders

(76) Inventor: David Stanley Hoyle, Maungaturoto (NZ)

Correspondence Address: MERCHANT & GOULD PC, P.O. BOX 2903, MINNEAPOLIS, MN, 55402-0903, US

(21) Appl. No.: 10/991,659

(22) Filed: Nov. 18, 2004

(30) Foreign Application Priority Data
Nov. 19, 2003 (NZ) 529637

(51) Int. Cl. B60K 17/28

(52) U.S. Cl. 180/53.8

(57) ABSTRACT

An agricultural spreader (200) includes one or more hydraulically actuated spreading means in a hydraulic circuit including a hydraulic pump. The hydraulic pump is driven by at least one drive wheel (6) mounted on drive wheel mounting means (7) and engageable with at least one ground wheel (9) of the spreader. The hydraulic pump is adapted to supply hydraulic fluid at a substantially constant required flowrate to the one or more hydraulically actuated spreading means (2) when a rotational speed of the ground wheel (9) is greater than or equal to a minimum required rotational speed.

### TECHNICAL FIELD

The present invention relates to improvements to agricultural spreaders, and in particular, but not exclusively, to improvements to apparatus and methods for driving the spreading means of such spreaders.

### BACKGROUND ART

At present, some trailer type agricultural spreaders receive their motive power from a drive wheel which engages one of the spreader's ground wheels and is driven by friction between the drive wheel and ground wheel, or a direct connection to the ground wheel. One example of such a system is disclosed in the Applicant's U.S. Pat. No. 5,180,112.

The power from the drive wheel is transmitted to the spreading means by a mechanical drivetrain involving gears, chains and the like. The speed of the spreading means, of which spinners and blowers are examples, may be directly proportional to the groundspeed of the spreader. This may be undesirable as it may mean that there is only one operating speed of the spreader at which the spreading means are working at the desired rotational speed.

A further problem may be that the torque required to turn the spreading means may increase with the speed of the spreader, and the engaging force between the drive wheel and the ground wheel may not be sufficient to prevent slippage.

A further problem may be that there is no way to remotely engage and disengage the drive wheel.

### OBJECT OF THE INVENTION

It is an object of a preferred embodiment of the invention to provide an agricultural spreader and/or a method of providing a variable engagement force between a drive wheel of an agricultural spreader and a ground wheel of said agricultural spreader and/or a method of powering an actuation means associated with an agricultural spreader, which will overcome or ameliorate problems with such agricultural spreaders and/or methods at present, or at least one which will provide the public with a useful choice.

Other objects of the present invention may become apparent from the following description, which is given by way of example only.

### DISCLOSURE OF THE INVENTION

According to one aspect of the present invention there is provided an agricultural spreader including one or more hydraulically actuated spreading means in a hydraulic circuit including a hydraulic pump means, the hydraulic pump means driven by at least one drive wheel mounted on drive wheel mounting means and engageable with at least one ground wheel of said spreader, wherein said hydraulic pump means is adapted to supply hydraulic fluid at a substantially constant required flowrate to said one or more hydraulically actuated spreading means when a rotational speed of said at least one ground wheel is greater than or equal to a minimum required rotational speed.

Preferably, an output of said hydraulic pump means may be in fluid communication with an input of said one or more hydraulically actuated spreading means and an output of said one or more hydraulically actuated spreading means is in fluid communication with an input of said hydraulic pump means.

Preferably, said required flowrate may be adjustable by an operator of the agricultural spreader.

Preferably, said drive wheel mounting means may be provided with one or more hydraulic actuator means adapted to provide an engagement force between said at least one drive wheel and said at least one ground wheel which is proportional to a pressure of a hydraulic fluid supplied to said hydraulically actuated spreading means.

Preferably, said hydraulic actuator means may be supplied with hydraulic fluid from upstream of said hydraulically actuated spreading means.

Preferably, said agricultural spreader may include at least one hydraulically actuated rotatable component which, in use, has a rotational inertia, the spreader further including power transmission means adapted to, in use, use energy stored as said rotational inertia in said at least one rotatable component to power an actuator means to move said drive wheel mounting means between a driving position, wherein said drive wheel is substantially engaged with at least one of said at least one ground wheel, and a non-driving position, wherein said drive wheel is substantially disengaged from said at least one ground wheel, when drive from said drive wheel is not required.

Preferably, said hydraulically actuated rotatable component may be a spinner.

Preferably, said power transmission means may include said hydraulic circuit.

Preferably, said agricultural spreader may include a second drive wheel mounted on second drive wheel mounting means and provided with second hydraulic actuator means for moving said second drive wheel between an engaged and a non-engaged position, wherein said second hydraulic actuator means are in fluid communication with said hydraulic circuit.

According to a second aspect of the present invention there is provided an agricultural spreader including at least one ground wheel, one or more hydraulically actuated spreading means, a drive wheel mounted on drive wheel mounting means and engageable with at least one of said at least one ground wheel, said drive wheel driving a hydraulic pump means adapted to supply said one or more hydraulically actuated spreading means with hydraulic fluid at a variable spreading means supply pressure, wherein said drive wheel mounting means is provided with one or more hydraulic actuator means adapted to provide an engagement force between said drive wheel and said at least one ground wheel which is proportional to said variable spreading means pressure, thereby increasing said engagement force when said variable spreading means supply pressure increases.

Preferably, said hydraulic actuator means may be supplied with hydraulic fluid from upstream of said hydraulically actuated spreading means.

Preferably, said one or more hydraulically actuated spreading means may include one or more of a spinner and/or blower.

According to a third aspect of the present invention there is provided an agricultural spreader including at least one ground wheel and at least one hydraulically actuated rotatable component which, in use, has a rotational inertia, the spreader further including at least one drive wheel mounted on drive wheel mounting means provided with one or more actuator means adapted to move said drive wheel mounting means between a driving position, wherein said drive wheel is engaged with at least one of said at least one ground wheel, and a non-driving position, wherein said drive wheel is disengaged from said at least one ground wheel, the drive wheel, in use, driving said at least one hydraulically actuated rotatable component via power transmission means when said drive wheel mounting means is in said driving position, wherein said power transmission means is adapted to use energy stored as said rotational inertia in said at least one hydraulically actuated rotatable component to power said actuator means to move said drive wheel mounting means between said driving position and said non-driving position when drive from said drive wheel is not required.

Preferably, said power transmission means may include a hydraulic circuit and said actuator is hydraulically powered.

Preferably, said one or more hydraulically actuated rotatable component includes one or more of a spinner and/or blower.

According to a fourth aspect of the present invention a method of providing a variable engagement force between a drive wheel of an agricultural spreader and a ground wheel of said agricultural spreader includes;
i) providing said drive wheel with hydraulic actuator means adapted to provide an engagement force between said drive wheel and said at least one ground wheel of said agricultural spreader which is proportional to a pressure of a hydraulic fluid supplied to said hydraulic actuator means;
ii) driving a hydraulic pump means with said drive wheel;
iii) supplying one or more hydraulically actuated spreading means with hydraulic fluid from said hydraulic pump means at a variable spreading means pressure;
iv) supplying said hydraulic actuator means with hydraulic fluid at a pressure proportional to said variable spreading means pressure, thereby varying said engagement force in proportion to said variable spreading means pressure.

Preferably, said hydraulic actuator means may be supplied with fluid from upstream of said hydraulically actuated spreading means.

According to a fifth aspect of the present invention there is provided a method of powering an actuation means associated with an agricultural spreader, said actuation means adapted to move a drive wheel mounting means provided with a drive wheel between a driving position, wherein said drive wheel is engaged with a ground wheel of said agricultural spreader, and a non-driving position, wherein said drive wheel is disengaged from said ground wheel, the method including;
i) providing said agricultural spreader with one or more hydraulically actuated rotatable component;
ii) driving said one or more rotatable component when said drive wheel mounting means is in said driving position, thereby storing energy in said rotatable component as rotational inertia;
iii) powering said actuation means with said energy stored as said rotational inertia when movement of said drive wheel mounting means from said driving position to said non-driving position is required.

Preferably, said drive wheel may actuate a hydraulic pump and said at least one spreading means and said actuator are hydraulically powered.

Preferably, said one or more hydraulically actuated spreading means may include one or more of a spinner and/or blower.

According to a further aspect of the present invention, an agricultural spreader is substantially as herein described, with reference to the accompanying drawings.

According to a further aspect of the present invention, a method of providing a variable engagement force between a drive wheel and a ground wheel of an agricultural spreader is substantially as herein described, with reference to the accompanying drawings.

According to a still further aspect of the present invention, a method of powering an actuation means associated with an agricultural spreader is substantially as herein described, with reference to the accompanying drawings.

Further aspects of the invention, which should be considered in all its novel aspects, will become apparent from the following description given by way of example of possible embodiments of the invention.

### BRIEF DESCRIPTION OF THE DRAWINGS

FIG. 1. Is a schematic diagram of a hydraulic power transmission system according to one possible embodiment of the present invention.

FIG. 2. Is a diagrammatic side view of an agricultural spreader with a drive wheel in a non-engaged position, according to one possible embodiment of the present invention.

FIG. 3. Is a diagrammatic side view of the agricultural spreader of FIG. 2 with the drive wheel in the engaged position.

### BEST MODE FOR PERFORMING THE INVENTION

The term “agricultural spreader” is used herein to indicate mobile devices which distribute material such as fertilizer, salt, sand and/or manure over land, and in particular to trailer type agricultural spreaders which are towed behind a vehicle.

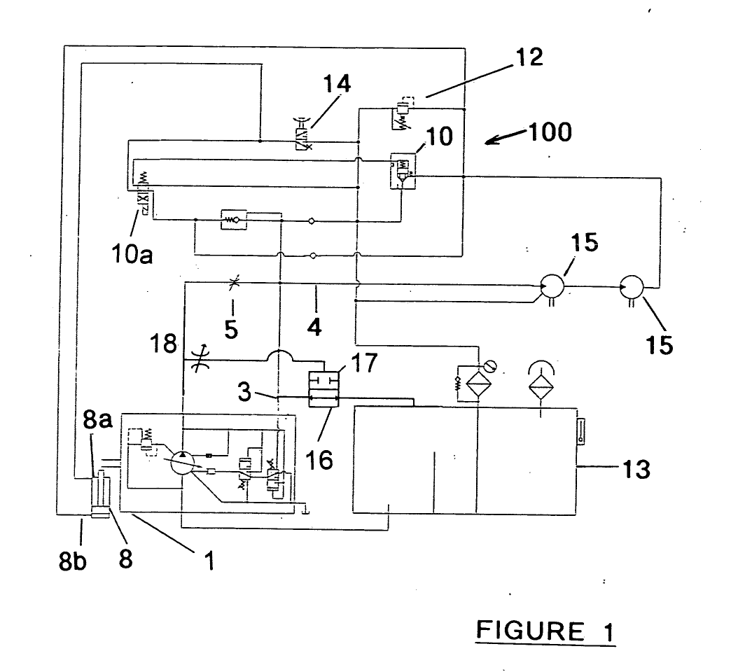

Referring to FIGS. 1 to 3, an agricultural spreader 200 according to a preferred embodiment of the present invention includes a load sensing, pressure compensated hydraulic pump 1 driving the hydraulic motors 15 of a pair of hydraulically actuated spreading means, in this case spinners 2, via a power transmission means, in this case a hydraulic system or circuit indicated generally by arrow 100. The output of the pump 1 is in fluid communication with an input to the spinner motors 15, and the outputs of the spinner motors 15 are in fluid communication with the input to the pump 1, via a tank 13.

The term “spreading means” is used herein to describe any suitable means of spreading agricultural material, and includes spinners, blowers and the like. The spreading means in the embodiment illustrated includes a hydraulic motor 15 and a rotating spinner disc 11 for spreading agricultural material. In a preferred embodiment each hydraulic motor 15 is of a type which is able to act as a pump if the output shaft is rotated.

The load sensing pump 1 has a pressure or load sensor 3 which senses the pressure in the pump output line 4 downstream of a variable valve 5. The pump output line 4 is connected to the input to the spinner motors 15. The pump 1 is of a type which is able to change its stroke to ensure that the flowrate at the output 4 remains substantially constant for a given setting of the variable valve 5, regardless of the speed at which the pump 1 is being driven, provided the pump 1 is being driven at or above a minimum speed. The variable valve 5 allows the rate of flow of hydraulic fluid to the spinner motors 15 to be set, and thus controls the rotational speed of the spinners 2. As the load sensing pump 1 provides a stable output at almost all speeds, the speed of the spinners 2 may be controlled substantially independently of the groundspeed of the spreader 200.

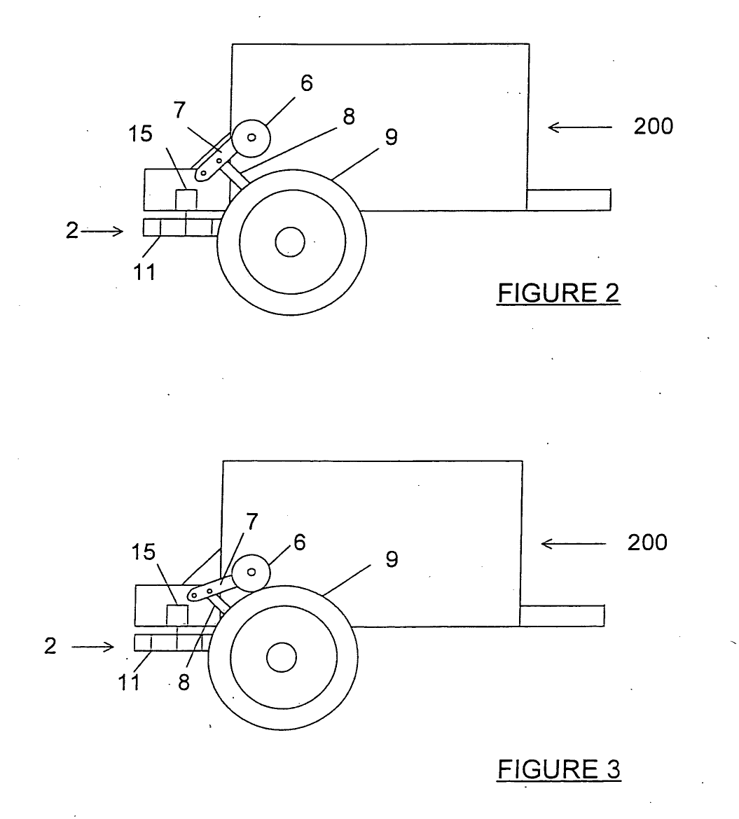

Referring next to FIGS. 2 and 3, the pump 1 is driven by a drive wheel 6 which is provided with drive wheel mounting means, for example a rotatable arm 7.

The rotatable arm 7 and drive wheel 6 maybe moveable between a non-engaged position, as illustrated in FIG. 2, in which the drive wheel 6 is spaced apart from a ground wheel 9 of the spreader 200, and an engaged or driving position, as illustrated in FIG. 3, in which the drive wheel 6 is engaged with the ground wheel 9.

A hydraulic actuator 8, preferably a double acting piston type having a first side 8a and a second side 8b, may be provided between the axle (not shown) of the drive wheel 9 and the rotatable arm 7, to move the rotatable arm 9 and drive wheel 6 between the engaged and non-engaged positions. Other mounting locations of the actuator 8 are of course possible, for example, in one preferred embodiment the actuator may extend between the body of the spreader and the rotatable arm 7.

In the engaged position the first side 8a of the actuator 8 is supplied with hydraulic fluid from between the variable valve 5 and the spinner motors 15. The pressure of this fluid is therefore proportional to the pressure supplied to the spinner motors 15, and the actuator 8 provides an engaging force between the drive wheel 6 and the ground wheel 9 which is proportional to the pressure supplied to the spinner motors 15 by the pump 1. This engaging force may assist in decreasing slippage between the drive wheel 6 and ground wheel 9.

In an alternative embodiment (not shown) the hydraulic fluid supplied to the first side 8a of the actuator 8 may be taken from the outlet of the pump 1, rather than downstream of the variable valve 5.

In some embodiments the drive wheel 6 may also drive a conveying means (not shown) which conveys material to the spinners 2. Alternatively a second drive wheel and mounting means (not shown) may be provided to drive the conveying means. The separate drive wheel may drive the conveyor by a separate hydraulic circuit, or more preferably by a direct mechanical transmission, but in either case the second drive wheel may also be provided with second drive wheel mounting means and second hydraulic actuator means for moving the second drive wheel between an engaged and non-engaged position. The second hydraulic actuator means may preferably be connected to the hydraulic circuit which powers the spreading means.

References herein to hydraulic fluid “supplied” to a component from a point in the hydraulic system are intended to include instances of a connection between said point and said component wherein there is substantially no flow between said point and said component, but where the pressure of the hydraulic fluid at the entrance to the component is substantially equal to the pressure of the hydraulic fluid at said point in the hydraulic system.

When the operator wishes to lift the drive wheel 6 to the non-engaged/non-driving position, a valve 10 located between the spinner motors 15 and the hydraulic reservoir or tank 13 is closed. In a preferred embodiment the valve 10 may be a pilot operated valve and may be closed by a solenoid valve 10a which is controlled from the cab of the towing vehicle.

With the valve 10 closed the pressure of the fluid leaving the pump 1 is supplied to the second side 8b of the actuator 8. This causes the actuator 8 to begin lifting the drive wheel 6 off the ground wheel 9 to the non-engaged position due to the greater surface area of the piston on the second side 8b of the actuator 8.

When the drive to the drive wheel 6 ceases, typically just before the drive wheel 6 is completely disengaged from the ground wheel 9, the inertia in the rotating portion of the spinners 2, primarily the spinner discs 11, causes the spinner discs 11 and spinner motors 15 to continue to rotate.

In a preferred embodiment the continued rotation of the spinner discs 11 causes a continued flow of hydraulic fluid through the hydraulic motors 15, and a corresponding continued pressurization of the fluid downstream of the spinner motors 15. The pressure of this fluid may continue to be directed to the second side 8b of the actuator 8, thereby allowing the actuator 8 to continue to lift the drive wheel 6 towards the non-engaged position.

A pressure accumulator (not shown) charged with pump pressure while the spreading means are in use may additionally or alternatively be used to supply pressure to the second side 8b of the actuator 8. Alternatively other spreading means (not shown) having rotating components, for example blowers, may be used to pressurize the fluid to the actuator 8 after the driving wheel 6 has disengaged from the ground wheel 9. In a still further alternative embodiment (not shown) a hydraulic motor may be added to the hydraulic circuit in order to provide a suitable rotatable component. The hydraulic motor may be provided with a flywheel, if necessary, in order to ensure that sufficient rotational inertia is stored to allow the drive wheel 6 to be lifted. In a still further alternative embodiment one or more other rotatable components may be provided with flywheels in order to allow them to perform this function.

A pressure relief valve 12 allows some of the hydraulic fluid to flow back to the tank 13 if the pressure downstream of the spinner motors 15 is higher than required. A check valve (not shown) may also be used immediately downstream of the spinner motors 15 to prevent leakage of the hydraulic fluid back through the spinner motors 15 when the drive wheel 6 is in the non-engaged position.

A manually operable valve 14 is preferably provided between the first side 8a of the actuator 8 and the tank 13. If an operator wishes to lift the drive wheel 6 to the non-engaged position by hand, the manually operable valve 14 may be opened to allow the fluid from the first side 8a of the actuator 8 to drain to the tank 13 relatively freely, thereby reducing the force necessary to manually move the rotatable arm 7 and drive wheel 6 to the non-engaged position. Alternatively the valve 10a may be manually operable to provide the same function.

In a particularly preferred embodiment a “soft start” feature is provided for the drive wheel 6 by providing a valve 16, preferably a pilot operated valve, between the input to the load sensor 3 and the tank 13. The valve 16 is biased to an open position, and is closed when the fluid from the output from the pump 1 reaches a threshold pressure on the pilot input 17. A valve or orifice 18 between the output of the pump 1 and the pilot input 17 controls the time required for the pressure at the pilot input 17 to reach the threshold pressure, and therefore controls the delay before the valve 16 closes.

By biasing the valve 16 to an open position, the pressure sensed by the pump 1 when the drive wheel 6 is first moved from the non engaged position to the engaged position is at or close to zero. This means that the pump 1 will provide the minimum flow on startup, and will therefore provide the minimum resistance to the drive wheel 6 when the drive wheel 6 is first moved to the engaged position.

If no equivalent to this system is used, then pressure sensed by the pump 1 when the drive wheel 6 is moved to the engaged position may be relatively high, causing the pump 1 to start at or near its maximum flow rate. This requires a relatively high torque to be transmitted through the drive wheel 6, which in some cases may be sufficient to cause the drive wheel 9 to lock or skid.

In an alternative embodiment the valve 16 may be electrically actuated and/or may be controlled by alternative control means such as, for example, remote control by an operator or an electronic control means.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the scope of the appended claims.

1. An agricultural spreader including one or more hydraulically actuated spreading means in a hydraulic circuit including a hydraulic pump means, the hydraulic pump means driven by at least one drive wheel mounted on drive wheel mounting means and engageable with at least one ground wheel of said spreader, wherein said hydraulic pump means is adapted to supply hydraulic fluid at a substantially constant required flowrate to said one or more hydraulically actuated spreading means when a rotational speed of said at least one ground wheel is greater than or equal to a minimum required rotational speed.

2. The agricultural spreader of claim 1 wherein an output of said hydraulic pump means is in fluid communication with an input of said one or more hydraulically actuated spreading means and an output of said one or more hydraulically actuated spreading means is in fluid communication with an input of said hydraulic pump means.

3. The agricultural spreader of claim 2 wherein said required flowrate is adjustable by an operator of the agricultural spreader.

4. The agricultural spreader of claim 2 wherein said drive wheel mounting means is provided with one or more hydraulic actuator means adapted to provide an engagement force between said at least one drive wheel and said at least one ground wheel which is proportional to a pressure of a hydraulic fluid supplied to said hydraulically actuated spreading means.

5. The agricultural spreader of claim 4 wherein said hydraulic actuator means is supplied with hydraulic fluid from upstream of said hydraulically actuated spreading means.

6. The agricultural spreader of claim 2 including at least one hydraulically actuated rotatable component which, in use, has a rotational inertia, the spreader further including power transmission means adapted to, in use, use energy stored as said rotational inertia in said at least one rotatable component to power an actuator means to move said drive wheel mounting means between a driving position, wherein said drive wheel is substantially engaged with at least one of said at least one ground wheel, and a non-driving position, wherein said drive wheel is substantially disengaged from said at least one ground wheel, when drive from said drive wheel is not required.

7. The agricultural spreader of claim 6 wherein said hydraulically actuated rotatable component is a spinner.

8. The agricultural spreader of claim 7 wherein said power transmission means includes said hydraulic circuit.

9. The agricultural spreader of claim 1 including a second drive wheel mounted on second drive wheel mounting means and provided with second hydraulic actuator means for moving said second drive wheel between an engaged and a non-engaged position, wherein said second hydraulic actuator means are in fluid communication with said hydraulic circuit.

10. An agricultural spreader including at least one ground wheel, one or more hydraulically actuated spreading means, a drive wheel mounted on drive wheel mounting means and engageable with at least one of said at least one ground wheel, said drive wheel driving a hydraulic pump means adapted to supply said one or more hydraulically actuated spreading means with hydraulic fluid at a variable spreading means supply pressure, wherein said drive wheel mounting means is provided with one or more hydraulic actuator means adapted to provide an engagement force between said drive wheel and said at least one ground wheel which is proportional to said variable spreading means pressure, thereby increasing said engagement force when said variable spreading means supply pressure increases.

11. The agricultural spreader of claim 10 wherein said hydraulic actuator means is supplied with hydraulic fluid from upstream of said hydraulically actuated spreading means.

12. The agricultural spreader of claim 10 wherein said one or more hydraulically actuated spreading means include one or more of a spinner and/or blower.

13. An agricultural spreader including at least one ground wheel and at least one hydraulically actuated rotatable component which, in use, has a rotational inertia, the spreader further including at least one drive wheel mounted on drive wheel mounting means provided with one or more actuator means adapted to move said drive wheel mounting means between a driving position, wherein said drive wheel is engaged with at least one of said at least one ground wheel, and a non-driving position, wherein said drive wheel is disengaged from said at least one ground wheel, the drive wheel, in use, driving said at least one hydraulically actuated rotatable component via power transmission means when said drive wheel mounting means is in said driving position, wherein said power transmission means is adapted to use energy stored as said rotational inertia in said at least one hydraulically actuated rotatable component to power said actuator means to move said drive wheel mounting means between said driving position and said non-driving position when drive from said drive wheel is not required.

14. The agricultural spreader of claim 13 wherein said power transmission means include a hydraulic circuit and said actuator is hydraulically powered.

15. The agricultural spreader of claim 14 wherein said one or more hydraulically actuated rotatable component includes one or more of a spinner and/or blower.

16. A method of providing a variable engagement force between a drive wheel of an agricultural spreader and a ground wheel of said agricultural spreader includes;
i) providing said drive wheel with hydraulic actuator means adapted to provide an engagement force between said drive wheel and said at least one ground wheel of said agricultural spreader which is proportional to a pressure of a hydraulic fluid supplied to said hydraulic actuator means;
ii) driving a hydraulic pump means with said drive wheel;
iii) supplying one or more hydraulically actuated spreading means with hydraulic fluid from said hydraulic pump means at a variable spreading means pressure;
iv) supplying said hydraulic actuator means with hydraulic fluid at a pressure proportional to said variable spreading means pressure, thereby varying said engagement force in proportion to said variable spreading means pressure.

17. The method of claim 16 wherein said hydraulic actuator means is supplied with fluid from upstream of said hydraulically actuated spreading means.

18. A method of powering an actuation means associated with an agricultural spreader, said actuation means adapted to move a drive wheel mounting means provided with a drive wheel between a driving position, wherein said drive wheel is engaged with a ground wheel of said agricultural spreader, and a non-driving position, wherein said drive wheel is disengaged from said ground wheel, the method including;
iv) providing said agricultural spreader with one or more hydraulically actuated rotatable component;
v) driving said one or more rotatable component when said drive wheel mounting means is in said driving position, thereby storing energy in said rotatable component as rotational inertia;
vi) powering said actuation means with said energy stored as said rotational inertia when movement of said drive wheel mounting means from said driving position to said non-driving position is required.

19. The method of claim 18 wherein said drive wheel actuates a hydraulic pump and said at least one spreading means and said actuator are hydraulically powered.

20. The method of claim 19 wherein said one or more hydraulically actuated spreading means include one or more of a spinner and/or blower.
